(19) United States
(12) Patent Application Publication
(10) Pub. No.: US 2007/0072758 A1
(43) Pub. Date: Mar. 29, 2007

(54) Punch/crease plate

(76) Inventor: Petrus Van Oosterhout, Goes (NL)

Correspondence Address: BACON & THOMAS, PLLC, 625 SLATERS LANE, FOURTH FLOOR, ALEXANDRIA, VA, 22314, US

(21) Appl. No.: 11/526,581

(22) Filed: Sep. 26, 2006

(30) Foreign Application Priority Data
Sep. 27, 2005 (BE) 2005/0471

(51) Int. Cl. B31B 1/14

(52) U.S. Cl. 493/355

(57) ABSTRACT

Improved punch/crease plate for punching and creasing plate material (4), such as cardboard, paper, plastic or the like, whereby one or several grooves (2) are provided in this punch/crease plate (1) up to a certain depth there where the creased lines (3) are to be realized in the plate material (4) to be tooled, characterized in that the punch/crease plate (1) consists of two metal plates (5, 6) glued onto each other, whereby, before the plates are glued together, slots (8) are provided in one of the plates (5) so as to form the above-mentioned grooves (2).

The present invention concerns an improved punch/crease plate for punching and creasing a plate material such as paper, cardboard, plastic or the like.

Such punched and creased plate material is used for example for displays, packagings or the like in order to obtain a packaging punched out of paper, plastic or cardboard, which punched shape is also provided with push-through lines or what are called creased lines in appropriate places along which the punched shape can be folded so as to form a packaging, for example.

To this end, a cardboard or another plate material is provided in the known manner between what is called a punch plate or a punch/crease plate and a punch or what is called a die, whereby the punch plate or punch/crease plate is provided with grooves where the creased lines are to be provided, whereas the die is formed of a wooden block or another plate material which can be laser-tooled in which knives are provided on the one hand having the contour of the die to be punched, and in which ribs are provided opposite the above-mentioned grooves in the punch plate or punch/crease plate on the other hand, such that when the die is pressed against the punch plate or punch/crease plate, for example by means of a press, the desired form can be punched out of the cardboard by the knives, and the cardboard is pressed in the grooves by the ribs so as to form creased lines.

This tooling can be done in a known flat or rotating punch machine.

The punch or punch/crease plates used are usually alternate plates with a relatively small thickness of 0.5 to 2 millimeter which are provided on a supporting plate of a press under the die.

Such creasing techniques are already known which consist of a metal plate onto which bending strips made of plastic or plastic plate material are glued there where the creased lines are to be formed in which the grooves for forming the creased lines are milled out.

A disadvantage is that the life of such creasing materials is rather short due to wear in terms of the number of punches that can be realized with them, since the wear of the creasing material has a negative influence on the crease quality in the material to be punched.

Punch/crease plates made of a massive, metal plate of for example 1 to 6 millimeter are known as well, whereby the grooves for the creased lines are milled out directly in the top surface of these massive plates up to a certain depth.

Such plates are disadvantageous in that the accuracy of the grooves is not always optimal and in that their realization by means of for example milling is relatively time-consuming and thus expensive.

In the case of packagings, data are often embossed in order to provide more depth as an embellishment or, for example, in Braille, so that the packagings can be easily recognized by blind persons or visually handicapped as well.

For this embossing, use is made of what is called a patrix in the form of a plate with a relief corresponding to the required embossing, which is glued onto the punch plate or punch/crease plate, and a corresponding matrix which is provided opposite the above-mentioned patrix on or in the die.

The accuracy with which the patrix must be positioned opposite the matrix makes it necessary to make a new punch or punch/crease plate for every new embossing, even for packagings with identical crease and cutting patterns.

If no new punch or punch/crease plate is applied in case of changes, the used patrixes or matrixes on the plate will have to be removed, which is usually not possible without causing any damage, or they will have to be preserved on the alternate punch plate. In the latter case, a new punch or punch/crease plate must be taken for a new embossing or embossing test.

This has a negative effect on the production cost of packagings which, although they have the same dimensions, still require a different embossing, which implies a lot of work to remove and renew the patrixes or matrixes or to provide a new plate.

Moreover, such patrixes and matrixes are relatively vulnerable, meaning that they can be easily damaged when changing the punch or punch/crease plates.

The present invention aims to remedy the above-mentioned and other disadvantages by providing an improved punch/crease plate for punching and creasing plate material, such as cardboard, paper, plastic or the like, whereby one or several grooves are provided in this punch/crease plate up to a certain depth there where the creased lines are to be realized in the plate material to be tooled and whereby the punch/crease plate consists of two metal plates glued onto each other, whereby, before the plates are glued together, slots are provided in one of the plates so as to form the above-mentioned grooves.

An advantage is that the above-mentioned grooves are very easy to realize, i.e. in an economical manner and with an accurate depth by cutting slots in one of the constituent plates and by subsequently simply gluing these plates together.

The above-mentioned slots are preferably cut by means of a water jet or a laser cutter, such that the grooves can be made very precisely with minimal tolerances, which improves the quality of the punched and creased product.

The plates are preferably made of a type of steel with an appropriate hardness, so that punch/crease plates can be obtained having a longer life than usual up to now.

According to a preferred embodiment, an improved punch/crease plate according to the invention has a thickness between 0.7 and 1.5 millimeter, which makes it suitable for use as an alternate punch/crease plate.

The invention further makes it possible to provide an embossing in the plate material to be tooled by using an alternate plate with the positive or negative form of the required embossing, which plate can be fit in an opening which has been cut in the plate with slots by means of a water jet or laser cutter so as to form a recessed part in the punch/crease plate.

Thanks to the used cutting technique, the dimensions of the above-mentioned recessed part can be adapted with great precision to the dimensions of the alternate plate, such that the alternate plate is held in the recessed part when in use without being able to shift and can be positioned with great accuracy opposite the corresponding negative part on the die.

This makes it possible to provide several embossings with one and the same punch/crease plate by simply providing another alternate plate with a new embossing.

This is advantageous when, for example, the same packaging is used with different embossings, for example as the same packaging is used to pack different products, as is customary among others in the tobacco industry, the pharmaceutical industry and the cosmetics industry.

In order to better explain the characteristics of the invention, the following preferred embodiments of an improved punch/crease plate according to the invention are given as an example only without being limitative in any way, with reference to the accompanying drawings, in which:

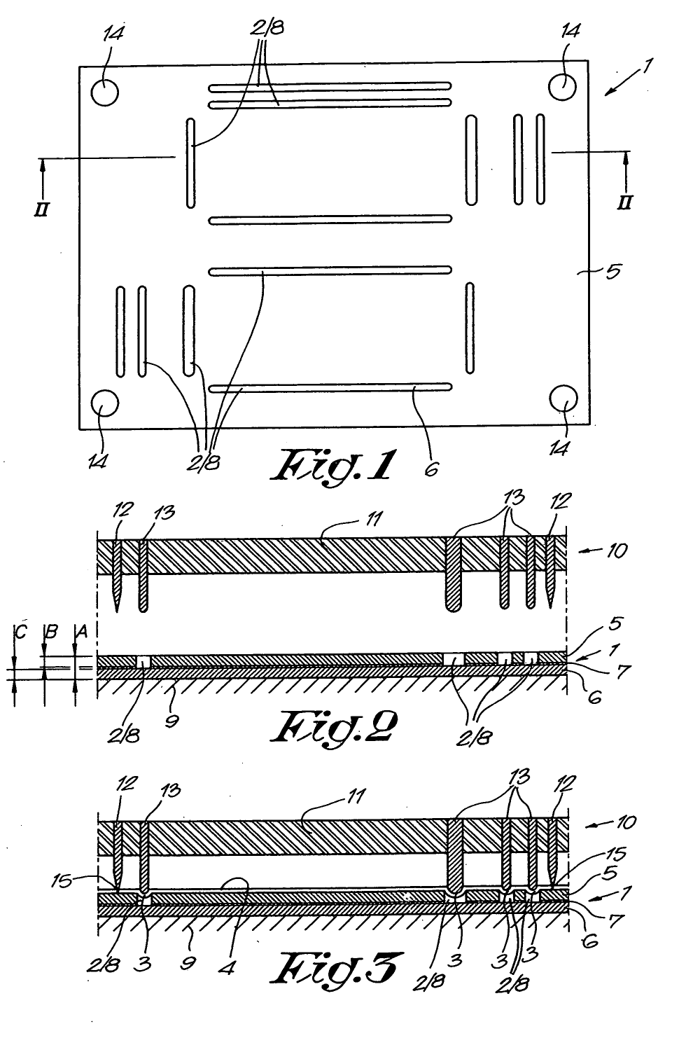

FIG. 1 schematically represents a top view of an improved punch/crease plate according to the invention;

FIG. 2 represents a section according to line II-II in FIG. 1 to a larger scale, but applied in a punch device;

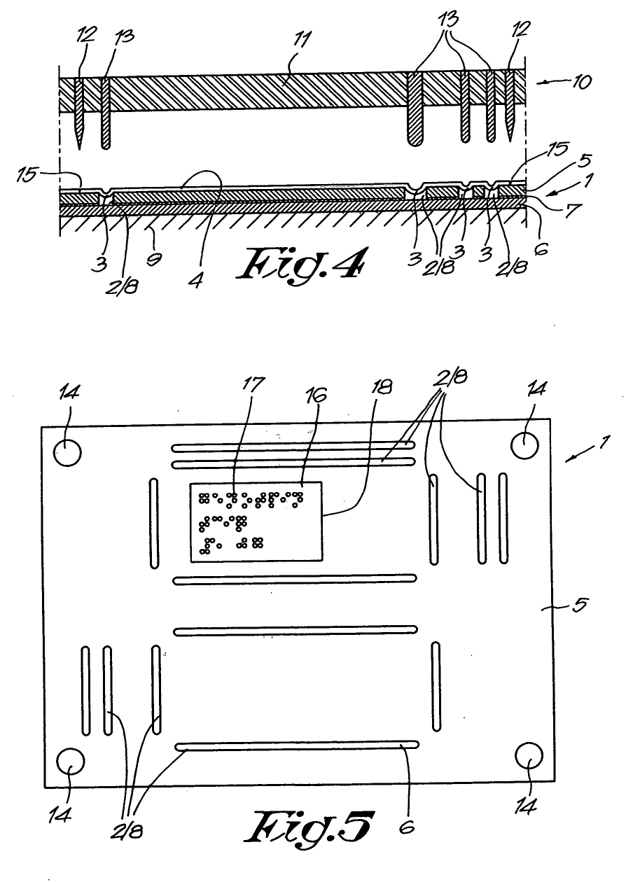

FIGS. 3 and 4 represent the device of FIG. 2 during successive stages when in use;

FIG. 5 represents a variant of a punch/crease plate according to FIG. 1.

The punch/crease plate 1 which is represented in FIGS. 1 to 4 comprises a number of grooves 2 in the known manner with a certain depth, designed to form creased lines or folding lines 3 in a plate material 4 to be tooled such as cardboard, paper or plastic.

The punch/crease plate 1 according to the invention consists of two metal plates 5, 6 respectively, preferably made of steel or stainless steel, which are glued together, for example by means of an adhesive layer 7.

In the top plate 5, before the plates 5 and 6 are glued together, are provided slots 8 so as to form the above-mentioned grooves 2, whereby these slots are preferably cut out of the top plate 5 by means of a water jet or laser cutter, which makes it possible to dimension the slots 8 with great accuracy.

The thickness A of the punch/crease plate 1 is preferably situated between 0.7 and 1.5 millimeter, whereby the top plate 5 has a thickness B of for example 0.5 to 1 millimeter, whereas the thickness C of the other plate 6 is situated between 0.2 and 1 millimeter.

Such a punch/crease plate 1 is used in a punch/crease machine which is provided with a table 9 on which the punch/crease plate 1 is provided and on top of which is situated a punch or a so-called die 10 which can be pushed down by means of a press (not represented in the figures) or the like up to the punch/crease plate 1.

The die 10, as is known, is formed for example of a wooden block 11 in which are provided knives 12 to punch the desired form in the plate material and in which are also provided downward protruding ribs 13, situated opposite the grooves 2 in the punch/crease plate 1 so as to form the creased lines 3 in the plate material 4 to be tooled.

The use of a punch/crease plate 1 in a punch/crease machine is known and is illustrated by means of FIGS. 2 to 4.

FIG. 2 represents the open position of the punch/crease machine whereby the die 10 is situated in a topmost position at a distance from the table 9 and whereby a punch/crease plate 1 according to the invention is provided on the table 9.

In order to precisely position the punch/crease plate 1 under the die 10, fitted holes 14 may for example be provided in the punch/crease plate 1 which work in conjunction with fitted dowels in the table 9.

The plate material 4 to be tooled is placed on top of the punch/crease plate 1, after which the die 10 is pushed down, as represented in FIG. 3, such that cuts 15 are formed in the plate material 4 through the agency of the knives 12 and such that the plate material 4 is pressed in the grooves 2 by the ribs 13 so as to form creased lines 3.

Next, the die 10 is raised again, as represented in FIG. 4, after which the tooled plate material 4 can be taken out of the machine and the punched form can be folded along the creased lines 3, for example so as to form a packaging or the like.

FIG. 5 represents a variant of a punch/crease plate 1 according to the invention whereby, in order to provide an embossing in the plate material 4 to be tooled, an alternate plate 16 is provided with a positive or negative relief 17 of the required embossing, for example a superscription in Braille, which alternate plate 16 fits in an opening 18 cut in a top plate 5 by means of a water jet or laser cutter so as to form a recessed part in the punch/crease plate 1 in which the alternate plate 16 fits.

The thickness of the alternate plate 16 is equal to the thickness B of the top plate 5.

Opposite the alternate plate 16, the negative form of the relief 17 is provided in the die 10, such that an embossing can be made in a single movement in the plate material 4 to be tooled when punching and creasing.

In order to hold the alternate plate 16 against the punch/crease plate 1, a little bit of grease or oil or glue can be provided between the alternate plate 16 and the punch/crease plate 1, or use can be made for example of the magnetic attraction in case the alternate plate 16 and/or the punch/crease plate 1 and/or the table 9 is/are magnetic.

If another embossing must be made for one and the same packaging, one only has to replace the alternate plate 16 by an alternate plate showing the new, required embossing without having to replace the entire punch/crease plate 1.

It is clear that in this case, the alternate plate 16 must not be positioned by making a print of the alternate plate 16 by means of the die as was customary until now, but the alternate plate 16 is pre-fabricated and corresponds exactly to the position of the matrix (mold) or patrix part in the die 10.

It is also clear that the die 10 must not necessarily be made of wood, but that also other plate material such as plastic, metal, reinforced massive or composed plate materials or a combination thereof are appropriate.

The present invention is by no means limited to the embodiments given as an example and represented in the accompanying drawings; on the contrary, an improved punch/crease plate according to the invention can be made in all sorts of shapes and dimensions while still remaining within the scope of the invention.

1. Improved punch/crease plate for punching and creasing plate material (4), such as cardboard, paper, plastic or the like, wherein one or several grooves (2) are provided in this punch/crease plate (1) up to a certain depth there where the creased lines (3) are to be realized in the plate material (4) to be tooled, characterized in that the punch/crease plate (1) comprises two metal plates (5, 6) glued onto each other, and wherein, before the plates are glued together, slots (8) are provided in one of the plates (5) so as to form the above-mentioned grooves (2).

2. Improved punch/crease plate according to claim 1, wherein the above-mentioned slots (8) are cut by means of a water jet or laser cutter.

3. Improved punch/crease plate according to claim 1, wherein the metal out of which the above-mentioned plates (5, 6) are made is steel.

4. Improved punch/crease plate according to claim 3, wherein the metal out of which the above-mentioned plates (5, 6) are made is stainless steel.

5. Improved punch/crease plate according to claim 1, wherein the plate has a thickness (A) between 0.7 and 1.5 millimeter.

6. Improved punch/crease plate according to claim 5, wherein the thickness (B) of the plate (5) with the slots (8) is situated between 0.5 and 1 millimeter, whereas the thickness (C) of the other plate (6) is situated between 0.2 and 1 millimeter.

7. Improved punch/crease plate according to claim 1, wherein, in order to provide an embossing in the plate material (4) to be tooled, it is provided with an alternate plate (16) with the positive or negative relief (17) of the required embossing, which alternate plate (16) fits in an opening (18) which has been cut in the plate (5) with slots (8) by means of a water jet or a laser cutter so as to form a recessed part in the punch/crease plate (1).

8. Improved punch/crease plate according to claim 7, wherein the thickness of the alternate plate (16) is equal to the thickness (B) of the plate (5) with slots (8).

9. Improved punch/crease plate according to claim 7, wherein the alternate plate (16) is held in the above-mentioned recessed part of the punch/crease plate (1) by applying an adhesive between the alternate plate and the punch/crease plate.

10. Improved punch/crease plate according to claim 9, wherein the adhesive is glue, grease or oil.

11. Improved punch/crease plate according to claim 7, wherein the alternate plate (16) is held in the above-mentioned recessed part of the punch/crease plate by means of magnetism.

12. Improved punch/crease plate according to claim 7, wherein it can work in conjunction with a die (10) in which, opposite the alternate plate (16), is provided a patrix or a matrix, whereby the alternate plate (16) is not positioned by making a print of the alternate plate (16) by means of the die, but is prefabricated and corresponds exactly to the position of the matrix or patrix part in the die (10).

13. Improved punch/crease plate according to claim 12, wherein the die (10) is made of plate material in wood, plastic, metal, reinforced massive or composed plate materials or a combination thereof.
